(19) United States
(12) Patent Application Publication
(10) Pub. No.: US 2019/0220108 A1
(43) Pub. Date: Jul. 18, 2019

(54) STYLUS HAVING PEN TIP ASSEMBLY AND END COVER SYNCHRONIZED IN MOTION

(71) Applicant: ADONIT CO., LTD, Taipei City (TW)

(72) Inventors: Yueh-Hua LI, Taipei City (TW); Yu-Kuang HOU, Taipei City (TW); Shu-Ming GUO, Taipei City (TW)

(21) Appl. No.: 15/871,067

(22) Filed: Jan. 15, 2018

(51) Int. Cl. G06F 3/0354; G06F 3/038

(52) U.S. Cl. CPC G06F 3/03545; G06F 3/0383

(57) ABSTRACT

A stylus has a pen tip assembly and an end cover synchronized in motion. The stylus includes a barrel, a pen tip assembly, a drive circuit unit, an end cover, and an elastic element. The pen tip assembly is electrically connected to the drive circuit unit. The end cover is connected to the pen tip assembly, and an end portion is exposed from the end cover. When the pen tip assembly is pressed, the end portion is moved together with the end cover from an initial position, the pen tip assembly moves inwardly toward the barrel and compresses the elastic element. When the elastic element is restored to release the pen tip assembly, the pen tip assembly and the end cover are together returned to the initial position to avoid a deduction or a loss in signal strength.

### TECHNICAL FIELD

The present invention relates to a stylus and, in particular, to a stylus having a pen tip assembly and an end cover synchronized in motion.

### BACKGROUND

Among consumer electronic products in the market today, there are more and more electronic products that utilize a touch panel. For example, a capacitance touch panel achieves touch control utilizing capacitive variations of static electricity generated by proximity or contact between a human body and a touch panel. According to where the capacitive variation occurs, the position where a user approaches or contacts the touch panel by his/her finger can be detected.

Active-type capacitance touch panels in the market are extensively used for having advantages such as high sensitivity and allowing handwriting by fingers or a stylus. As shown in FIG. 8, a conventional active-type stylus at least includes an end cover A, a pen tip B moves back or forth with respect to the end cover A, a barrel C assembled to the end cover A, and a control unit D installed inside the barrel C. The control unit D has at least one pressure sensor unit E. When the active-type stylus contacts the touch panel (not illustrated), the pen tip B retracts or sticks out to contact the pressure sensor unit E, and the control unit D detects the magnitude of the force exerted by the stylus according to a value detected by the pressure sensor unit E.

In order to prevent occurrence of signal feedback between the pen tip B (i.e. a receive end; Rx) and the end cover A (i.e. a transmit end; Tx), the pen tip B is covered by a shielding member, so that no interference occurs between the Tx and Rx. However, during usage of the active-type capacitance stylus, the pen tip B retracts toward the control unit D and gets closer to the end cover A, and as a result, the shielding member becomes more and more closer to the end cover A, thus causing occurrence of signal feedback between the pen tip B and the end cover A. Consequently, this results in reduction/loss of signal strength, or even worse, inability to sense signals. In addition to that, a conventional stylus has many components, which causes a tolerance problem, thus it is troublesome, time and labor consuming to assemble the stylus.

In view of this, the inventor studied various technologies and created an effective solution in the present disclosure.

### SUMMARY

It is an objective of the present invention to provide a stylus having a pen tip assembly and an end cover synchronized in motion, whereby avoid reduction/loss of signals from signal feedback.

It is another objective of the present invention to provide a stylus having a pen tip assembly and an end cover synchronized in motion, which is formed by insert molding.

Accordingly, the present invention provides a stylus having a pen tip assembly and an end cover synchronized in motion, for collaborating with an electronic device. The stylus includes a barrel, a drive circuit unit, a pen tip assembly, an end cover, and an elastic element. The barrel is hollow inside. The drive circuit unit is disposed inside the barrel for sending a touch control signal. The pen tip assembly is installed in the barrel and electrically connected to the drive circuit unit. The pen tip assembly receives a signal from the electronic device. The end cover is connected to the pen tip assembly, an end portion of the pen tip assembly is exposed from the end cover, an exposed distance is formed between a top of the end portion and a rim of the end cover, and the end cover is electrically connected to the drive circuit unit to send the touch control signal to the electronic device. The elastic element is disposed inside the barrel and connected to the pen tip assembly. When the pen tip assembly is pressed, the end portion of the pen tip assembly and the end cover are moved together from an initial position, the pen tip assembly moves inwardly toward the barrel and compresses the elastic element without changing the exposed distance. When the elastic element is restored to release the pen tip assembly, the pen tip assembly and the end cover are together returned to their initial positions.

The pen tip assembly includes a sleeve installed inside the barrel, a tip rod inserted into one end of the sleeve, a wire connected to the tip rod and inserted through the sleeve, and a protection cover covering a tip of the tip rod, wherein the tip rod is inserted through the end cover, and the end portion is a tip of the tip rod. Furthermore, the end cover includes an internal threaded portion, one end of the sleeve includes an external threaded portion, the internal threaded portion of the end cover is threadedly fastened to the external threaded portion of the sleeve to be coupled to the pen tip assembly. Therefore, the end cover and the pen tip assembly can be moved together to avoid signal feedback problems between the pen tip assembly (i.e. Rx) and the end cover (i.e. Tx).

The sleeve includes an insulating tube for insertion of the wire, a first conductive pipe receiving the insulating tube, an insulating outer pipe partially receiving the first conductive pipe, a second conductive pipe receiving the insulating outer pipe, and an insulating ring receiving the second conductive pipe. The insulating tube, the first conductive pipe, the insulating outer pipe, the second conductive pipe, and the insulating ring are integrally formed by insert molding. As a result, the stylus causes no tolerance problems in assembling, thus saving assembly time, costs, and achieving rapid and easy assembling.

When the pen tip assembly of the stylus moves back and forth with respect to the barrel, the pen tip assembly and the end cover are moved together, i.e. when the pen tip assembly and the end cover retract inwardly or stick out, the exposed distance between them remains unchanged (the same), and as a result, loss or reduction of the signal strength is effectively avoided.

### BRIEF DESCRIPTION OF THE DRAWINGS

The disclosure will become more fully understood from the detailed description and the drawings given herein below for illustration only, and thus does not limit the disclosure, wherein:

FIG. 1 is a perspective view illustrating a stylus having a pen tip assembly and an end cover synchronized in motion;

FIG. 2 is a partial exploded view illustrating the stylus having the pen tip assembly and the end cover synchronized in motion;

FIG. 3 is an exploded view illustrating the pen tip assembly of the stylus;

FIG. 4 is an assembled view illustrating the pen tip assembly of the stylus;

FIG. 5 is a cross-sectional view illustrating the stylus;

FIG. 6 is an enlarged cross-sectional view of FIG. 5, before the pen tip assembly is moved together with the end cover;

FIG. 7 is another enlarged cross-sectional view of FIG. 5, illustrating the pen tip assembly being moved together with the end cover; and

FIG. 8 is a partial cross-sectional view illustrating a conventional active-capacitance-type stylus.

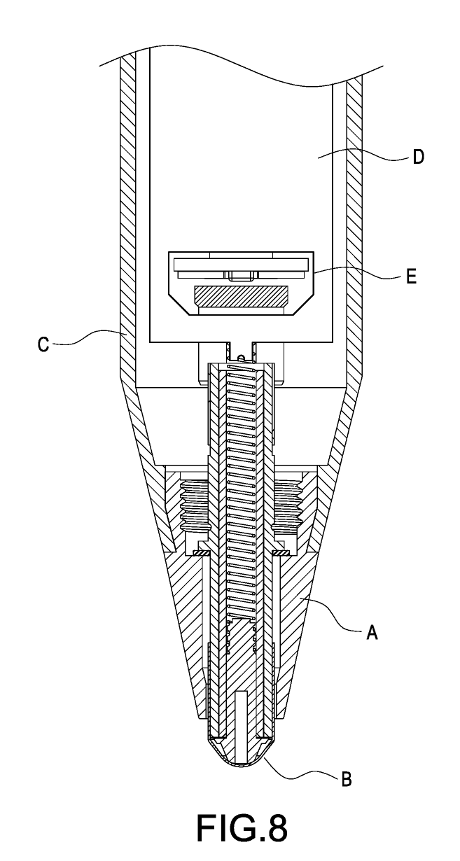

### DETAILED DESCRIPTION

Detailed descriptions and technical contents of the present invention are illustrated below in conjunction with the accompanying drawings. However, it is to be understood that the descriptions and the accompanying drawings disclosed herein are merely illustrative and exemplary and not intended to limit the scope of the present invention.

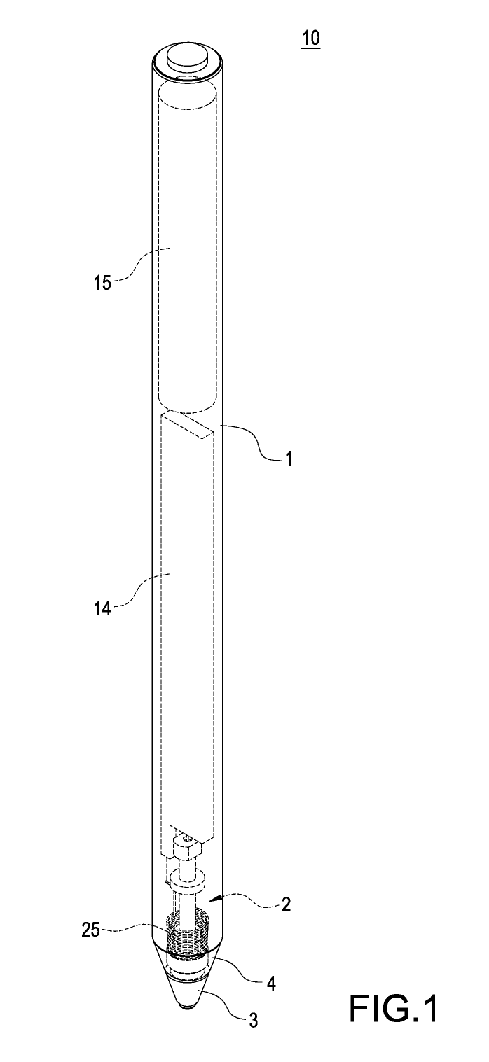

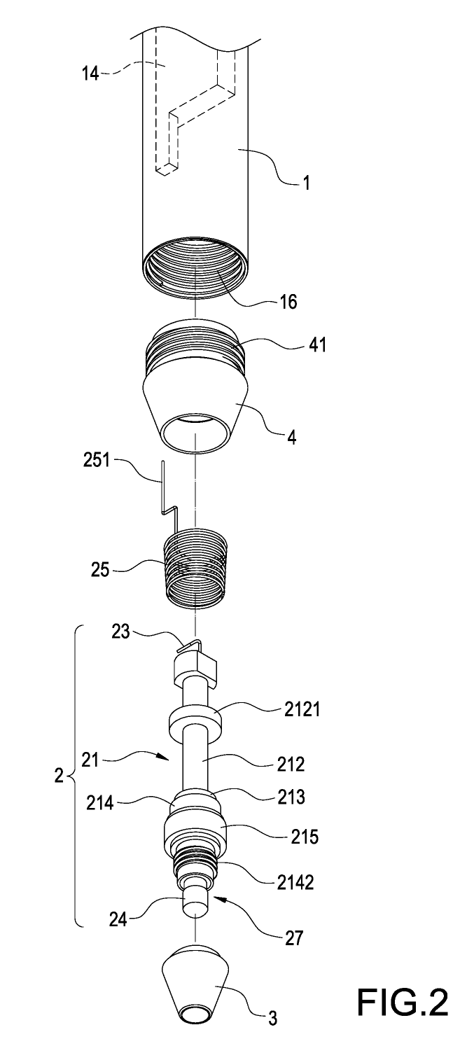

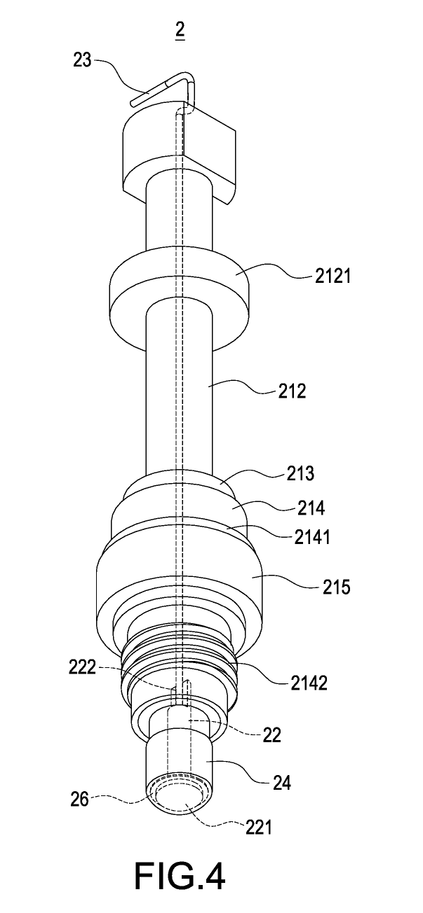

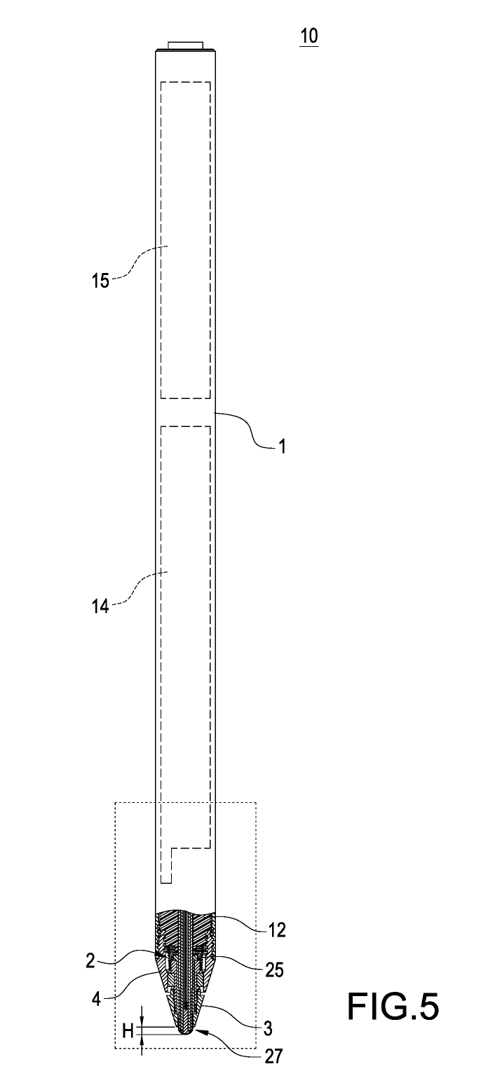

Referring to FIGS. 1 to 5, the present invention provides a stylus having a pen tip assembly and an end cover synchronized in motion, for collaborating with an electronic device (not illustrated). The electronic device is, for example, a smart phone, a tablet computer, a laptop computer, or other electronic device with a touch screen.

The stylus 10 includes a barrel 1, a drive circuit unit 14, a pen tip assembly 2, an end cover 3, and an elastic element 25. The stylus 10 is preferably an active-capacitance-type stylus. A power supply unit 15 electrically connected to the drive circuit unit 14 is installed inside the barrel 1. The drive circuit unit 14 includes, for example, a circuit board, a control unit electrically coupled to the circuit board, a pressure sensitive detector, and a signal transmitter, for sending a touch control signal (not labelled) for touch control. The power supply unit 15 can be a rechargeable battery, a storage battery or other suitable battery. The power supply unit 15 or other components are conventional techniques, so a detailed description thereof is omitted herein for brevity.

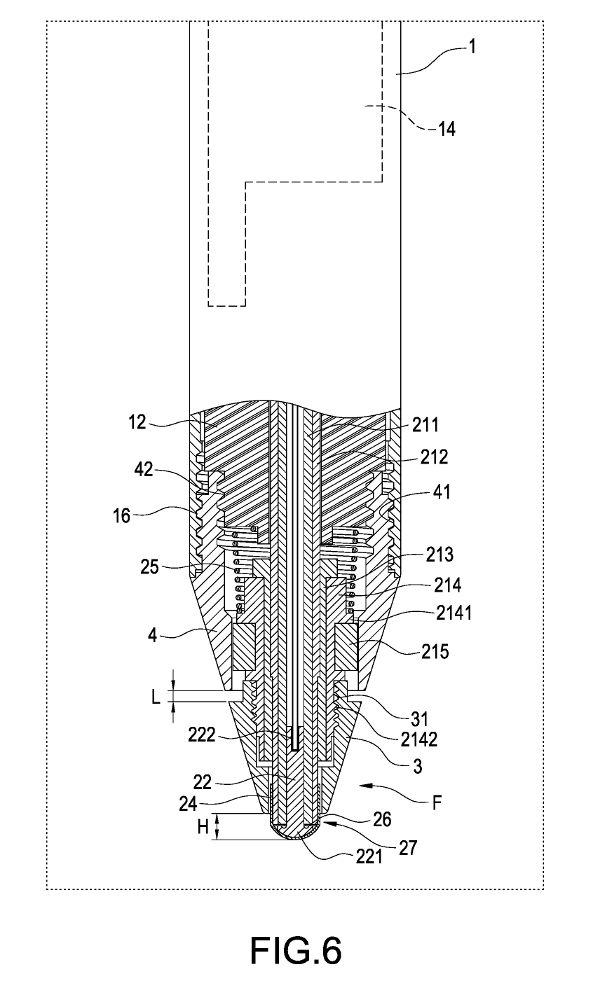

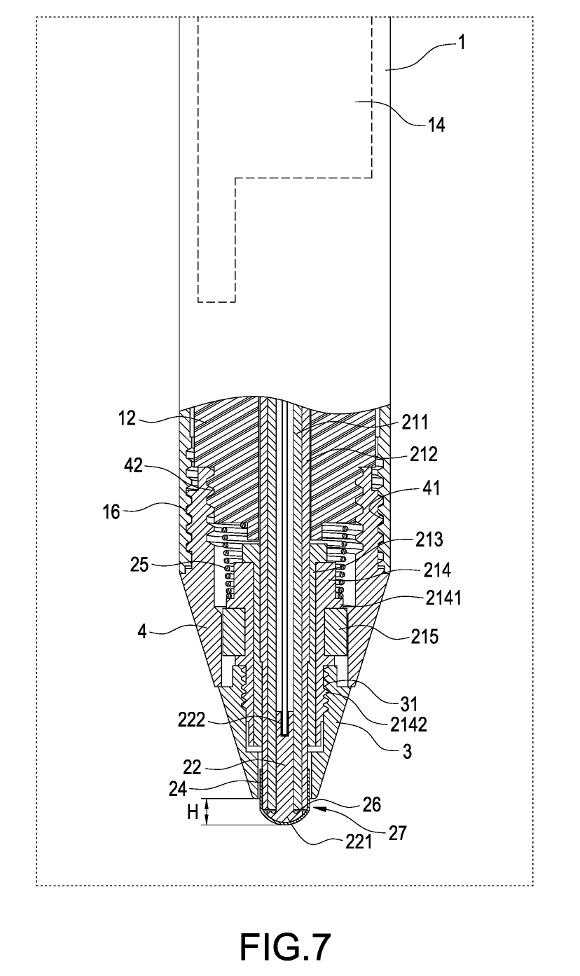

Referring to FIGS. 6 and 7, the barrel 1 includes a blocker portion (not illustrated) inside for limiting the pen tip assembly 2, a plug element 12 adjacent to the blocker portion, and an accommodating space (not illustrated) between the blocker portion and the plug element 12. The blocker portion and the plug element 12 are both made of a non-conductive material like plastic. The barrel 1 is hollow inside. The pen tip assembly 2 is installed inside the barrel 1 and electrically connected to the drive circuit unit 14. The pen tip assembly 2 is used to receive signals sent from the electronic device. In detail, the pen tip assembly 2 includes a sleeve 21 installed inside the barrel 1, a tip rod 22 inserted into one end of the sleeve 21, a wire 23 connected to the tip rod 22 and inserted through the sleeve 21, and a protection cover 24 covering a tip of the tip rod 22. The pen tip assembly 2 is movably disposed in the barrel 1 and is limited by the barrel 1.

The sleeve 21 includes a first protruding ring 2121 in the accommodating space. The first protruding ring 2121 is movable between the blocker portion and the plug element 12. The pen tip assembly 2 includes an elastic element 25 receiving the sleeve 21. When the stylus 10 is used, the sleeve 21 of the pen tip assembly 2 can be restored to an initial position F by the elastic element 25. Two ends of the elastic element 25 are in contact with a second protruding ring 2141 of the sleeve 21 and the plug element 12. The elastic element 25 is, for example, a compression spring. One end of the elastic element has an extension section 251 contacts the drive circuit unit 14 to form a ground connection.

The end cover 3 made of a conductive material is assembled to the pen tip assembly 2, and an end portion 27 of the pen tip assembly 2 is exposed from the end cover 3. An exposed distance H is formed between a top of the end portion 27 and a rim of the end cover 3, the end cover 3 is electrically connected to the drive circuit unit 14 to send the touch control signal to the electronic device. In detail, the end cover 3 is assembled to the sleeve 21 of the pen tip assembly 2, and a protection cover 24 covering the tip of the tip rod 22 is exposed from the end cover 22. The protection cover 24 is made of polyethylene terephthalate (PET) or other thermoplastic material, and the present invention is not limited in this regard. In the embodiment shown in FIGS. 6 and 7, the end cover 3 includes an internal threaded portion 31, one end of the sleeve 21 includes an external threaded portion 2142, the internal threaded portion 31 of the end cover 3 is fastened to the external threaded portion 2142 of the sleeve 21 to be firmly fixed to the pen tip assembly 2.

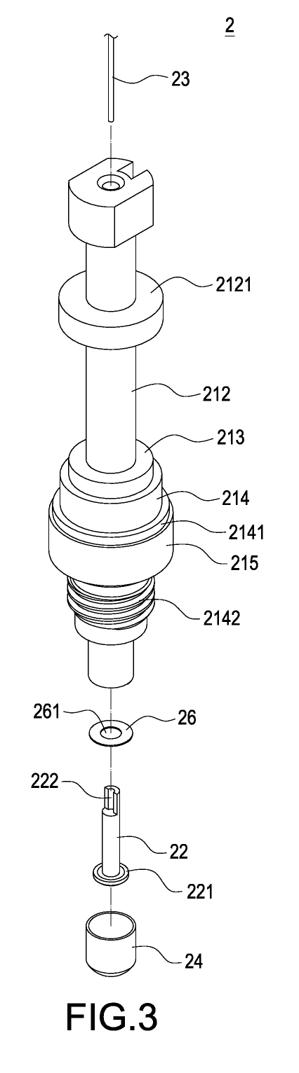

The tip rod 22 is preferably made of a conductive material such as steel, aluminum, iron, copper, alloy thereof, or even electrically conductive plastic consisting of the aforesaid metals or alloy thereof, so as to establish capacitance coupling with a touch panel and thereby generate a capacitance coupling signal. In FIGS. 3 to 6, the tip of the top rod 22 is preferably a disc-shaped portion 221, and a hollow tube 222 receiving the wire 23 is disposed opposite to the disc-shaped portion 221. The protection cover 24 covers the disc-shaped portion 221 to prevent the touch panel and the disc-shaped portion 221 from being damaged by the disc-shaped portion 221 directly contacting or tapping the touch panel.

In the present embodiment, an insulating casing 4 is threadedly fastened to the barrel 1 and the plug element 12, in such as manner to form a gap L between the insulating casing 4 and the end cover 3. One end of the insulating casing 4 has an external threaded portion 41 and an internal threaded portion 42, the external threaded portion 41 is fastened to an internal threaded portion 16 of the barrel 1, and the internal threaded portion 42 of the insulating casing 4 is threadedly fastened to an external threaded portion (not labelled) of the plug element 12. The sleeve 21 of the pen tip assembly 2 is inserted through the insulating casing 4 and the plug element 12. Therefore, the pen tip assembly 2 and end cover 3 can be moved together in the gap L. In other words, the insulating casing 4 has the same effect as the aforesaid blocker portion, i.e. confining the sleeve 21 of the pen tip assembly 2.

The sleeve 21 includes an insulating tube 211 for insertion of the wire 23, a first conductive pipe 212 receiving the insulating tube 211, an insulating outer pipe 212 partially receiving the first conductive pipe 212, and a second conductive pipe 214 receiving the insulating outer pipe 213. The first conductive pipe 212 includes a first protruding ring 2121, the second conductive pipe 214 includes a second protruding ring 2141, and the first protruding ring 2121 and the second protruding ring 2141 are arranged spaced apart. One end of the elastic element 25 is in contact with the second protruding ring 2141.

The conductive pipe 214 includes an external threaded portion 2142 on its outer circumferential surface near the end cover 3. The inner threaded portion 31 of the end cover 3 is threadedly fastened to the external threaded portion 2142 of the sleeve 21. In the embodiment shown in FIGS. 6 and 7, an insulating ring 215 receives the second conductive pipe 214. In this embodiment, the insulating tube 211, the first conductive pipe 212, the insulating outer pipe 213, the second conductive pipe 214, and the insulating ring 215 are integrally formed by means of insert molding. The first conductive pipe 212 and the second conductive pipe 214 are made of copper, steel, iron, aluminum, or alloy thereof. The insulating tube 211, the insulating outer pipe 213 and the insulating ring 215 are made of plastic or other suitable non-conductive material.

The sleeve 21 has an integral structure, so a pressure signal can be transmitted from the tip rod 22 to the drive circuit unit 14 via the wire 23, and a grounding signal can be effectively delivered from the second conductive pipe 214 to the drive circuit unit 14 via the elastic element 25. The sleeve 21 consisting of metal or plastic is integrally formed by insert molding, so the stylus 10 causes no tolerance problems in assembling, thus saving assembly time, costs, and achieving rapid and easy assembling.

It should be noted that, the pen tip assembly 2 further includes an insulating plate 26 between the sleeve 21 and the disc-shaped portion 221, and the insulating plate 26 has an opening 261 for insertion of the tip rod 22, so that the disc-shaped portion 221 is insulated from the first conductive pipe 212 of the sleeve 21 to prevent short-circuit.

Operation of the stylus 10 is described below. As shown in FIGS. 6 and 7, the pen tip assembly 2 and the end cover 3 are fastened to each other by means of threaded connection or other method. When the pen tip assembly 2 of the stylus 10 is pressed, the end portion 27 of the pen tip assembly 2 and end cover 3 are moved together from an initial position F and are retracted inwardly toward the barrel 1, without changing the exposed distance H, to compress the elastic element 25. When the elastic element 25 is restored to release the pen tip assembly 2, the pen tip assembly 2 and the end cover 3 are together restored to the initial position F.

In other words, the pen tip assembly 2 and the end cover 3 are moved together toward the drive circuit unit 14 until contacting the blocker portion and/or an insulating casing 4. The drive circuit unit 14 receives the signal sent from the electronic device by means of the pen tip assembly 2 (i.e. Rx), and sends out the touch control signal to the electronic device by means of the end cover 3 (i.e. Tx) for establishing capacitance coupling. Besides, the drive circuit unit 14 can determine the amount of the pressing force exerted by the pen tip assembly 21 according to the magnitude of the pressure signal sensed by the pen tip assembly 2. When the stylus 10 is not in use, the elastic element 25 is restored to together return the pen tip assembly 2 and the end cover 3 to the initial position F. When the pen tip assembly 2 of the stylus 10 moves back and forth with respect to the barrel 1 (i.e. the insulating casing 4), the pen tip assembly 2 and the end cover 3 are moved together, i.e. when the pen tip assembly 2 and the end cover 3 retract inwardly or stick out, the exposed distance H between them remains unchanged (the same), and as a result, loss or reduction of the signal strength is effectively avoided.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. A stylus having a pen tip assembly and an end cover synchronized in motion, for collaborating with an electronic device, the stylus comprising:
a barrel, the barrel is hollow inside;
a drive circuit unit disposed inside the barrel for sending a touch control signal;
a pen tip assembly, the pen tip assembly being installed in the barrel and electrically connected to the drive circuit unit, the pen tip assembly receiving a signal from the electronic device;
an end cover, the end cover being connected to the pen tip assembly, an end portion of the pen tip assembly being exposed from the end cover, an exposed distance being formed between a top of the end portion and a rim of the end cover, the end cover being electrically connected to the drive circuit unit to send the touch control signal to the electronic device; and
an elastic element disposed inside the barrel and connected to the pen tip assembly, wherein when the pen tip assembly is pressed, the end portion of the pen tip assembly and the end cover are moved together from an initial position, the pen tip assembly retracts inwardly toward the barrel and compresses the elastic element while the exposed distance remains the same; and when the elastic element is restored to release the pen tip assembly, the pen tip assembly and the end cover are together returned to the initial position.

2. The stylus having the pen tip assembly and the end cover synchronized in motion according to claim 1, wherein the pen tip assembly includes a sleeve installed inside the barrel, a tip rod inserted into one end of the sleeve, a wire connected to the tip rod and inserted through the sleeve, and a protection cover covering a tip of the tip rod, wherein the tip rod is inserted through the end cover, and the end portion is a tip of the tip rod.

3. The stylus having the pen tip assembly and the end cover synchronized in motion according to claim 2, wherein the end cover includes an internal threaded portion, one end of the sleeve includes an external threaded portion, the internal threaded portion of the end cover is threadedly fastened to the external threaded portion of the sleeve to be coupled to the pen tip assembly.

4. The stylus having the pen tip assembly and the end cover synchronized in motion according to claim 2, wherein the exposed distance is a distance from the tip of the tip rod covered by the protection cover to a portion of the sleeve.

5. The stylus having the pen tip assembly and the end cover synchronized in motion according to claim 2, wherein the sleeve includes an insulating tube for insertion of the wire, a first conductive pipe receiving the insulating tube, an insulating outer pipe partially receiving the first conductive pipe, and a second conductive pipe receiving the insulating outer pipe.

6. The stylus having the pen tip assembly and the end cover synchronized in motion according to claim 2, wherein the tip of the tip rod is a disc-shaped portion, and a hollow tube receiving the wire is disposed opposite to the disc-shaped portion.

7. The stylus having the pen tip assembly and the end cover synchronized in motion according to claim 5, wherein the first conductive pipe includes a first protruding ring, the second conductive pipe includes a second protruding ring, and the first protruding ring and the second protruding ring are arranged spaced apart.

8. The stylus having the pen tip assembly and the end cover synchronized in motion according to claim 5, wherein the second conductive pipe includes an external threaded portion, the end cover includes an internal threaded portion, so that the end cover is threadedly fastened to the sleeve.

9. The stylus having the pen tip assembly and the end cover synchronized in motion according to claim 5, further comprising an insulating ring receiving the second conductive pipe, wherein the insulating tube, the first conductive pipe, the insulating outer pipe, the second conductive pipe, and the insulating ring are integrally formed by insert molding.

10. The stylus having the pen tip assembly and the end cover synchronized in motion according to claim 1, wherein the barrel includes a blocker portion inside, a plug element adjacent to the blocker portion, and an accommodating space between the blocker portion and the plug element, and the pen tip assembly includes a sleeve installed in the barrel.

11. The stylus having the pen tip assembly and the end cover synchronized in motion according to claim 10, wherein the sleeve includes a first protruding ring received in the accommodating space, and the first protruding ring is movable between the blocker portion and the plug element.

12. The stylus having the pen tip assembly and the end cover synchronized in motion according to claim 10, further comprising an insulating casing threadedly fastened to the barrel and the plug element, the sleeve being inserted through the insulating casing and the plug element.

13. The stylus having the pen tip assembly and the end cover synchronized in motion according to claim 1, one end of the elastic element includes an extension section, and the extension section contacts the drive circuit unit in the barrel.
